(19) United States
(12) Patent Application Publication
(10) Pub. No.: US 2015/0298427 A1
(43) Pub. Date: Oct. 22, 2015

(54) Multilayer Building Membrane with Foam Core

(71) Applicant: Hermann Hogg, (US)

(72) Inventor: Bernd Kronenberg, Wegberg (DE)

(21) Appl. No.: 14/648,275

(22) PCT Filed: Nov. 28, 2013
(86) PCT No.: PCT/EP2013/075024

§ 371 Date: Jun. 9, 2015

(30) Foreign Application Priority Data
Nov. 29, 2012 (DE) 10 2012 111 593.1

(51) Int. Cl. B32B 5/18; B32B 27/40; B32B 7/02; B32B 27/06; B32B 5/02; B32B 5/24

(52) U.S. Cl. CPC B32B 5/18; B32B 5/022; B32B 5/245; B32B 7/02; B32B 27/065; B32B 27/40; B32B 2266/0278; B32B 2307/3065; B32B 2307/73; B32B 2307/51; B32B 2307/546; B32B 2307/5825; B32B 2307/7246; B32B 2307/7265; B32B 2419/00; B32B 2419/06

(57) ABSTRACT

The invention relates to a multilayer building membrane with two outer layers, one of which is designed as a film layer that can be elastically extended in a unidirectional manner and which contains an elastically deformable thermoplastic urethane designated as TPU. A membrane core is arranged between the two outer layers of the building membrane and is connected to said two outer layers, and the building membrane has a tensile strength of at least 40% in the longitudinal and transverse directions and a tear resistance, based on a 50 mm wide membrane strip, of at least 120 N, a maximum sd value of 20 m with respect to the vapor permeability of the building membrane, and a value corresponding to a water column of at least 8 m with respect to the water permeability of the building membrane. The invention proposes that the membrane core has a foam layer which consists of a foamed thermoelastic material, wherein a foam layer adjoins each of the two outer layers. The invention further proposes a facade-sealing strip which is designed as strips made of an aforementioned building membrane. The invention additionally proposes a roofing sheet which is designed as strips made of an aforementioned building membrane.

### BACKGROUND INFORMATION

1. Field of the Invention

The invention relates to a multilayer building membrane.

2. Discussion of the Prior Art

Conventional multilayer membranes for buildings are known in the field as roofing sheets or façade films. The multilayer membrane has two outer layers of plastic film and these layers are generally designated the “film layers.” In these membranes, a fleece layer, for example, a layer of fiberglass is placed between the two outer film layers as a membrane core. The fleece layer is firmly bonded to the film layers, for example, is laminated or adhesively affixed. This layer is referred to as a reinforcing layer, because it imparts a slightly higher tensile strength to the plastic films. It can also have a strong influence on the thickness, i.e., the material thickness, of the building membrane, namely, when the layer constitutes more than 50% of the thickness of the material.

Single layer building membranes that are used as façade films are also known. These consist exclusively of a layer of a rubber-elastic or thermoplastic material modified with a softener, whereby the former is referred to as “rubber film” in the industry and typically has pores, for example, approximately 25 to 60 pores per square centimeter. These pores can be generated by needle-punching the rubber film. Such rubber films are constructed to be open to vapor diffusion and have a corresponding Sd-value of approximately 3 m. The term “Sd-value” refers to the thickness of a layer of air that provides the equivalent water vapor diffusion and is a conventional measurement in construction physics to denote the resistance that a component layer provides in opposing the water vapor diffusion. The Sd-value provides a graphic description of the diffusion resistance, in that it indicates the thickness that a calm layer of air has to have, in order to have the same rate of diffusion in its stationary state and under the same marginal conditions as the component layer being looked at has. Smaller Sd-values thus indicate a greater vapor diffusion and for that reason are advantageous.

The needle-punched rubber film also has, with regard to the impermeability to water, a value of approximately 200 mm water column, measured according to DIN EN 1928, Method B, at a test environment: DIN 50014-23/501-2. When evaluating water impermeability, the highest possible values are advantageous.

In contrast to the rubber films just mentioned, the façade films mentioned at the beginning have a vapor diffusion Sd-value of one meter or lower, and regarding impermeability to water, a value of 10 m water column or greater.

Façade films differ significantly from films that are used in above-ground construction, for example, in the area of roof construction: With roofing, the films are placed above a thermal insulation layer, such as, for example, mineral wool. Usually, a roof lath is provided on the outside on the films, which carries the actual roofing material, for example, roofing stones or baked clay roofing tiles. The roofing material of the roof presents a water guiding surface of the roof, so that the film extends parallel to the water-guiding surface of the roof. When used on a building façade, however, the film itself is the water-guiding surface.

### BRIEF SUMMARY OF THE INVENTION

The object of the invention is to improve a building membrane such, that it has excellent values for the vapor diffusion openness, as well as for water impermeability. It is a further object, that the building membrane have excellent mechanical resistance values against loads that are exerted on a façade film.

This object is achieved by a multilayer building membrane according to the invention that is a triple-layer membrane having two outer film layers and a foam core between the two layers. Surprisingly, the foam layer does not noticeably reduce the vapor diffusion, regardless of whether the foam is an open-cell or a closed-cell foam. The properties of the thermo-elastic plastic material allow vapor diffusion through the cell walls of the foam, whereby the material strength of these cell walls is significantly lower overall than the material strength of the foam layer. As a result, desired openness to vapor diffusion of the total building membrane is not determined by the foam layer, but rather, by the structure of the outer film layer. Thus, a vapor diffusion for the building membrane may be defined by suitable selection of the outer film layer, which has an Sd-value of at most 20 meters, for example, an Sd-value between 0.02 m and 20 m. In practical tests, Sd-values of less than 1 meter were achieved. The water impermeability can thus be significantly improved over that of conventional façade films, so that, with regard to water impermeability, the building membrane according to the invention has values of at least 8 m and, in practical tests, values as great as 20 m water column were achieved. It is technically possible, that water impermeability values of still higher water columns may be realized, such values, would, however, require an increased material consumption, something that may be a disadvantage both technically due to the correspondingly greater weight of the building membrane, and economically, because of higher material costs.

The good mechanical loadability is based on the combination according to the invention of an omnidirectional elastically deformable foam layer and a stretchable film layer. The foam layer ensures the elastic deformability of the building membrane with the corresponding memory ability, i.e., ability to return to the original dimensions. The elastic stretchability of the foam is not only given for a single specified direction, i.e., mono-directionally, but in practically all directions, namely in the length, width, and diagonal directions of the foam, thus, omnidirectionally. Because of this, the entire building membrane is stretchable, without delamination occurring, such as can occur when a non-stretchable or only mono-directionally stretchable foam layer is used. After being stretched, the entire building membrane is able to revert to its original form again, due to the elastic stretch behavior of all three layers, and thus, back to its original properties. The stretchability allows the building membrane, for example, to be pulled over a pipe connector, after a small opening has been cut into the building membrane. If the dimension of the cut opening is smaller than the diameter of the pipe connector, then the membrane fits snug against pipe connector. The end result is that the building membrane according to the invention exhibits sealing and elasticity properties of a so-called rubber- or EPDM film, albeit with a much greater vapor diffusion, lower surface weight, and lower production costs.

### DETAILED DESCRIPTION OF THE INVENTION

The inventive building membrane is a triple-layer membrane comprising two outer layers, at least one of the outer layers being a film layer, and a foam layer between the two outer layers as a membrane core. This embodiment of the building membrane has good thermal and acoustic insulation properties. The thickness of the material of the membrane core may range, for example, from 0.6 mm up to more than 10 mm, with a correspondingly stable foam. For many applications, a suitable thickness of the membrane material may be between 0.3 mm and 4 mm, and a suitable thickness of the respective film layer may be between 0.02 mm and 1.3 mm, whereby the thickness of the materials of the entire building membrane lie between 2 mm and 6 mm.

When used as a façade film, it may be advantageous that the building membrane be as lightweight as possible, in order to keep the weight load of the building membrane itself as low as possible. When used as a roofing sheet, on the other hand, it may be advantageous that the building membrane, and particularly, the membrane core, be thicker, in order to obtain the highest possible thermal and acoustic insulating effect. For example, a thicker membrane core provides greater acoustic insulation against pounding raine.

A strong bond of the foam layer with the two film layers ensures high mechanical loadability of the building membrane, the strong bond counteracting delamination. The foam is made from a thermoplastic elastomer, which guarantees the strong bond. The film layer also contains an elastically deformable material and is bonded with the foam in an extrusion process. In this process, the material that forms the film layer is bonded by extrusion directly from a broad slit jet with previously produced foam, so that, in addition to an actual mechanical meshing, a partial homogeneous melting takes place between the still melt-warm film layer and the foam. This bond eliminates the use of an adhesive or an adhesive agent, as a result, the building membrane is produced very economically. The building membrane produced in this manner also has a lower surface weight, which simplifies its handling, for example, it is easier to handle the building membrane when it is to be worked as a façade film in an upper floor of a building.

It is thereby intended that the film layer be elastically stretchable, just as the foam layer is, so that the building membrane has an added stretch strength of at least 40% in the length direction as well as in the width direction and a tear strength of at least 120 N, based on loading of a 50 mm wide strip. The building membrane according to the invention, thus, doesn't tear until it has been stretched to more than 40% of its original expanse, namely, to 1.4 times its original length. Practical test with the building membrane have shown stretch values of greater than 65% with loading in the length direction and more than 85% with loading in the width direction. Particularly, the stretch strength may lie between 40% and 1,000% in both named directions, whereby a stretch strength of 1,000% is technically manufacturable, but in the context of the present invention is given as a limit value, because too great a degree of stretch strength would foreseeably result in a building membrane that has an undesirably low inherent stability and would, due to its own weight, for example, stretch to an undesirably great degree.

Also, according to the invention, it is intended that the building membrane have a tear strength of at least 120 N, based on loading of a 50 mm wide strip. In contrast to the theoretical definition of a tear strength, which specifies a force per cross-sectional area, for example, in n/mm2, the tensile force is given for the practical definition here, within the context of the present invention, as the measurement at which a 50 mm wide strip made of the material of the building membrane tears. The same tear strength is attributed to material having varying thicknesses, in other words, the 50 mm wide test strip has cross-sectional areas of varying thicknesses of cross-sectional areas, if it tears when the same tensile force is applied.

The length and width directions of the building membrane are assessed subsequent to the production process. Thus, if the building membrane is wrapped around a drum in the circumferential direction of the drum, the length direction is in the circumferential direction and the width direction in the axial direction of the drum.

This stretchability of the building membrane, together with the high tear strength of 120 N on a conventional 50 mm wide test strip ensures that loads exerted on the membrane do not result in the membrane tearing. For example, when the building membrane is used as a façade film on a façade that is vented to the rear, and when wind loads are exerted on the façade, the pressure and suction effects acting on the façade film do not result in a failure, and particularly, not in a tearing of the building membrane.

A high tear strength is also advantageous during the process of installing the building membrane. If the building membrane is being installed, for example, in the roof area of a building, the tear strength aids in accident prevention. The building membrane according to the invention may protect persons from falling objects, because of its high tear strength. A high tear strength also provides some protection against falling accidents for the personnel installing the building membrane. For example, if a person should slip off a roof beam or roof lath of a roof construction, the tear-resistant building membrane may provide protection against stepping or falling through the membrane. Even if the building membrane yields somewhat and then tears, the resulting time delay may give the person the chance to grab and hold onto the roof truss, thereby preventing a more serious accident.

The second outer layer opposite the first outer layer that is a film layer may be formed from a fleece, so that the building membrane is particularly cost effective in its production. The fleece may help to limit the stretchability of the film layer and the membrane core, for example, by thermally fixing or by needle-punching the fleece to the film layer as a way to prevent an undesired over-stretching of the film layer, which could otherwise occur as the result of wind sucking forces acting on the façade.

It may be advantageous to provide both of the two outer layers of the building membrane as two film layers. As mentioned above, this is not disadvantageous if the film layer is suitably formed, as far as the desired property of vapor diffusion is concerned. Two adjacent building membranes may, in this embodiment with two outer film layers, be fused with each other, instead of just being adhesively fixed, so that a tight bond of these two adjacent building membranes is reliably and surely formed, over a long period of time. This can be particularly advantageous when the building membrane is used as a roofing sheet, and particularly so, the flatter the roof slope is relative the horizon. Hereinafter the embodiment of the building membrane having two outer film layers will be repeatedly mentioned, as an example, but it is understood that the present invention is not limited exclusively to such an embodiment. Rather, inventive subject matter relating to the embodiment of the two outer film layers also applies to an embodiment having a single film layer, as long as the single film layer is an outer layer.

In another advantageous embodiment, the two outer film layers are each formed of a monolithic plastic film. The term monolithic means that the film layers do not have actual pores, which may be mechanically created, but rather, the film layers are made from a material that has a molecular structure thicker and thinner areas, whereby the thinner areas of the molecular structure effect the permeability of the film. It is known in the field, that the sources that make the materials used to produce the film also provide information as to the vapor diffusion and the water impermeability, depending on the thickness of the manufactured product, i.e., what the vapor diffusion and water impermeability values are for an extruded film having a particular thickness. Depending on the material used and the indicated properties, the layer thickness of the film layer(s) may then be so adjusted, that the resulting building membrane has the desired properties.

In another embodiment of the blml according to the invention, the foam and/or the film layers are each formed from a thermoplastic urethane, that is, TPU. The layer thickness of the TPU may be so adjusted that the building membrane has the desired values regarding vapor diffusion and water tightness. Furthermore, an outer film layer made of TPU exhibits excellent tear strength values: If the building membrane serves as a façade film and is dragged, for example, over the edge of a scaffolding or over a projecting head of a nail or a screw, or when a tool is dragged along the building membrane, the excellent tear strength of the building membrane prevents or at least reduces the damage that is done to the building membrane.

An embodiment of the building membrane according to the invention in which the foam as well as the film layers are made of TPU provides a membrane with a particularly tight bond between the membrane core and the two film layers, because the different layers are made in an extrusion coating process, which eliminates the need to use adhesive agents that negatively impact cost and weight of the building membrane.

In yet another embodiment of the triple-layer building membrane according to the invention, the middle foam layer may be reinforced by means of a fleece layer. In other words: rather than the membrane core consisting solely of the foam layer, that is, being constructed as a single layer, the membrane core may have a triple-layer construction comprising a middle fleece layer and two outer foam layers. Placing a fleece, instead of foam, between two outer film layers that are in direct contact with the fleece may result in a phenomenon, in which the ends of the fleece fibers pierce into the film layer and, in doing so, endanger the intactness of the film layer. This is particularly a risk, if the film layer is subjected to mechanical stresses, for example, if the building membrane stretches or is stressed under pressure. This problem of piercing the film layer increases with decreasing thickness of the film layer. The triple layer construction of the membrane core, however, with the fleece layer sheathed on both sides by foam layers, provides an embodiment in which the tips of the fleece fibers extend into the foam, rather than the film layer. This embodiment allows very thin film layers to be used, which is economical as well as advantageous regarding weight and vapor diffusion of the building membrane.

The two foam layers of the triple-layer construction of the membrane core may be embodied differently, for example, they may have different material thicknesses. Or they may have different spatial weights, as a way to create a “harder” and a “softer” side of the building membrane. Or they may be made of two different materials. In any case, the membrane cores with the different foam layers provides an embodiment in which the properties of the two sides of the building membrane, i.e., a front and a rear side, or a top side and a bottom side, may be adjusted differently, depending on the intended application of the building membrane, for example, as a façade film or a roof sheet.

The fleece may also advantageously be made of a thermoplastic elastomer, for example, of TPU. Making the fleece and the foam layers of the same material provides for a tight bond between the fleece and foam layers, which has a positive influence on the strength of the building membrane.

In another embodiment, the fleece for the membrane core is formed as a meltblown product. This is advantageous, because it ensures elastic deformability with the corresponding memory.

The fleece layer may advantageously be self-adhesively or thermally fixed to the foam layers. This counteracts delamination of the building membrane. For example, the fleece layer does not act as a readily delaminating separation layer between the two foam layers, should suction forces act on the building membrane.

Advantageously the foam layer or the entire membrane core may have a low basis weight, such as, for example a basis weight of more than 40 g/m2 and at most 150 g/m2, so that a lightweight building membrane is created, one that does not lead to undesired mechanical loading of the building membrane simply due to its own weight, or possibly to a crack or a seam.

In another advantageous embodiment, the membrane core is made of hydrophobic material, in order to avoid the absorption of moisture into the one or two foam layers. This would increase the weight of the building membrane, as well as negatively influence the insulation effect that the fleece may provide. Also, at temperatures below 0 degrees C., the absorption of moisture may destroy the bond between the layers of the building membrane.

In yet another embodiment, a swelling substance may be included in the one or two foam layers and/or the fleece layer of the membrane core, so that the building membrane exhibits self-sealing properties. If a nail is driven through the building membrane or the surface of the building membrane is otherwise damaged, then moisture can penetrate into the building membrane. The swelling substance that is provided in the membrane core then swells in the presence of moisture, thereby preventing further ingress of moisture, so that, in the end, the building membrane remains tight, despite the damage. A material that is designated a Super Absorber, for example, is suitable as the swelling substance.

The swelling substance may be placed directly on the fibers of the fleece or and be provided as an enveloping layer on a part of the fleece fibers. The substance may also be incorporated as a separate material into the fleece and/or into the foam, for example, may be strewn in. A swelling substance in granulate form may, for example, be strewn into the foam, after the foam has been bonded with a first film layer and before the foam layer is bonded to the second film layer.

Furthermore, the embodiment of the foam or the fleece of the membrane core may be fire-retardant, so that the inventive building membrane may find the widest possible applications. It may be particularly advantageous in the fire-retardant embodiment of the membrane core that the fleece and/or the foam is self-quenching, thereby ensuring a particularly effective fire protection. The fire-retardant and possibly self-quenching membrane core may advantageously contain, for example, melamine resin or other commercially available materials, that impart the desired fire-retardant or self-quenching properties to the building membrane, so that the building membrane obtains the desired product properties with the use of lesser expensive raw materials. The membrane core may also be embodied such, that the building membrane acquires the desired product properties. For example, the additional materials may be incorporated into the hollow spaces in the foam and/or the fleece.

In a further advantageous embodiment, the building membrane according to the invention may be made into pre-fabricated façade sealing strips. Such façade sealing strips are used, for example, in transition areas between façade expanses and cut-outs in the façade, such as doors and windows, where the sealing strips provide a tight transition from the rest of the façade to the specific reveal or soffit. Accordingly, such façade sealing strips are cut much narrower than the building membrane that is typically made as a spooled product, which, for example, is placed on the market as a so-called façade film. For example, the façade sealing strips may have widths of about 20 cm, whereas the façade films used on the same façade may have a width between approximately 1 to 3 meters.

The façade sealing strips mentioned may be pre-fabricated advantageously in the most simple process possible, not only with regard to their dimensions, i.e., their width, but already provided with additional sealing elements. Thus, for example, it may be advantageous that the façade sealing strips are provided with an additional sealing profile, which may be made of, for example, an elastomeric or a foam material. Such a sealing profile strip may be constructed as a so-called weatherstrip, for example, that is made from an SK or butyl material and is adhesively fixed or fused with the building membrane that forms the façade sealing strips.

Depending on the embodiment of the building membrane, a vapor diffusion film may be created, which, aside from its stretchability and tear strength, satisfies essentially the demands for vapor diffusion and tightness against wind, as well as water impermeability, so that a final product is created for the building membrane use on building facades, a building membrane that is tear-resistant and constructed to reliably prevent delamination.

It may be advantageous, to flame both surfaces of the middle fleece layer of the membrane core, in order to improve the bond to the adjacent foam layer.

It is understood that the embodiments described herein are merely illustrative of the present invention. Variations in the construction of the building membrane may be contemplated by one skilled in the art without limiting the intended scope of the invention herein disclosed and as defined by the following claims.

1-20. (canceled)

21. A building membrane comprising:
two outer layers, of which a first outer layer is omnidirectionally elastically stretchable, is elastically deformable and contains thermoplastic urethane;
a membrane core that is provided between the two outer layers and that is bonded with the two outer layers; and
a foam layer made of a foamed thermoelastic material and incorporated into the membrane core, such that the foam layer contacts at least the first outer layer;
wherein the building membrane has a stretch strength of at least 40% in a length direction and in a width direction, a tear strength of at least 120 N, based on a 50 mm wide membrane strip, an Sd-value relating to vapor diffusion of at least 20 m, and a water column value defining water impermeability of at least 8 m.

22. The building membrane of claim 21, wherein the first outer layer is a film layer and the foam layer is bonded as an extrusion coating with the film layer.

23. The building membrane of claim 21, wherein the two outer layers are constructed as film layers.

24. The building membrane of claim 21, wherein the foam layer has two surfaces and each of the two surfaces is bonded with a corresponding one of the two outer layers.

25. The building membrane of claim 21, wherein the membrane core is a triple-layer construction having two foam layers and a middle layer therebetween.

26. The building membrane of claim 25, wherein the middle layer is constructed as a fleece.

27. The building membrane of claim 25, wherein the two foam layers exhibit different properties.

28. The building membrane of claim 27, wherein the two foam layers have different material thicknesses.

29. The building membrane of claim 27, wherein the two foam layers exhibit different basis weights.

30. The building membrane of claim 26, wherein the two foam layers are made of different materials.

31. The building membrane of claim 22, wherein the film layer is made from a monolithic plastic film.

32. The building membrane of claim 21, wherein the foam layer contains thermoplastic urethane.

33. The building membrane of claim 32, wherein the foam layer consists of thermoplastic urethane.

34. The building membrane of claim 22, wherein the outer film layer consists of thermoplastic urethane.

35. The building membrane of claim 21, wherein the foam layer includes a swelling substance.

36. The building membrane of claim 21, wherein the foam layer is hydrophobic.

37. The building membrane of claim 21, wherein the foam layer contains a fire-retardant.

38. The building membrane of claim 21, wherein the foam layer is self-quenching.

39. A façade sealing strip formed as a strip from a building membrane comprising two outer layers, of which a first outer layer is omnidirectionally elastically stretchable, is elastically deformable and contains thermoplastic urethane;
a membrane core that is provided between the two outer layers and that is bonded with the two outer layers; and
a foam layer made of a foamed thermoelastic material and incorporated into the membrane core, such that the foam layer contacts at least the first outer layer;
wherein the building membrane has a stretch strength of at least 40% in a length direction and in a width direction, a tear strength of at least 120 N, based on a 50 mm wide membrane strip, an Sd-value relating to vapor diffusion of at least 20 m, and a water column value defining water impermeability of at least 8 m.

40. A roof sheet that is formed of a strip made from a building membrane comprising two outer layers, of which a first outer layer is omnidirectionally elastically stretchable, is elastically deformable and contains thermoplastic urethane;
a membrane core that is provided between the two outer layers and that is bonded with the two outer layers; and
a foam layer made of a foamed thermoelastic material and incorporated into the membrane core, such that the foam layer contacts at least the first outer layer;
wherein the building membrane has a stretch strength of at least 40% in a length direction and in a width direction, a tear strength of at least 120 N, based on a 50 mm wide membrane strip, an Sd-value relating to vapor diffusion of at least 20 m, and a water column value defining water impermeability of at least 8 m.
